(19) United States
(12) Patent Application Publication
(10) Pub. No.: US 2012/0210114 A1
(43) Pub. Date: Aug. 16, 2012

(54) LOG FILE PROCESSING SYSTEM AND METHOD

(75) Inventor: SEN-FENG CHANG, Tu-Cheng (TW)

(73) Assignee: HON HAI PRECISION INDUSTRY CO., LTD., Tu-Cheng (TW)

(21) Appl. No.: 13/217,279

(22) Filed: Aug. 25, 2011

(30) Foreign Application Priority Data
Feb. 15, 2011 (TW) 100104839

(51) Int. Cl. G06F 9/00; G06F 15/16

(52) U.S. Cl. 713/2

(57) ABSTRACT

A remote server and method processes a log file generated by a cloud server of a data center. The remote server sets an operating system image file and inserts test commands into the operating system image file and installs the operating system in each cloud server using the operating system image file. The remote server executes test commands and receives a log file from each cloud server. The remote server creates a file name for each log file corresponding to the cloud server and stores the log files into a storage system.

### BACKGROUND

1. Technical Field

The embodiments of the present disclosure relate to installation technology, and particularly to a log file processing system and method.

2. Description of Related Art

A log file is a text file that records everything that happens in a computer. A user (e.g., the administrator) can analyze the log file of the computer to find out why a computer problem occurred. However, the log file is often stored in the same computer in which the log file is generated. If a large number of log files are generated by a large number of different computers (e.g., computers in a data center) and need to be analyzed, the user needs to access each computer and parse the log file of each computer one by one, which is not convenient and results in low efficiency. More useful and convenient methods to integrate the log files of such computers are desired by users.

### BRIEF DESCRIPTION OF THE DRAWINGS

FIG. 1 is a system view of one embodiment of a log file processing system.

FIG. 2 is a block diagram of one embodiment of a remote server which is included in FIG. 1.

FIG. 3 is a flowchart of one embodiment of a log file processing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

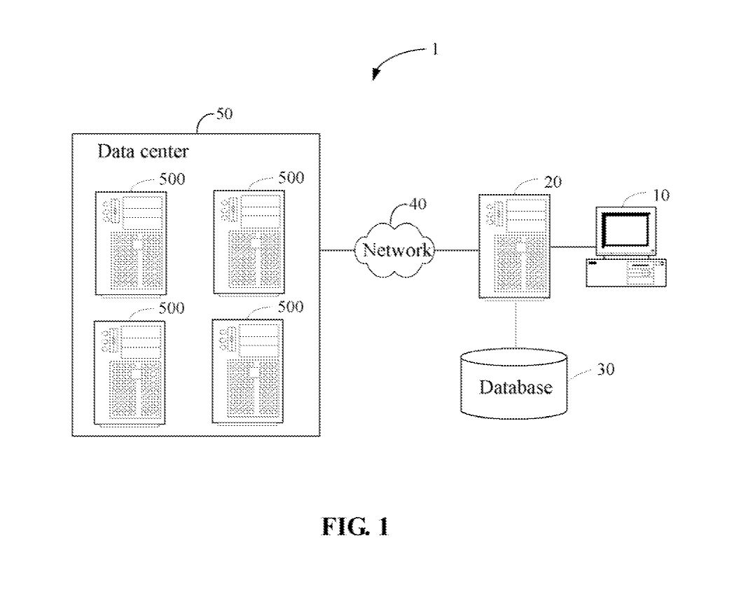

FIG. 1 is a system view of one embodiment of a log file processing system 1. In one embodiment, the log file processing system 1 may include a remote server 20 and a data center 50. The data center 50 is designed for cloud computing capability and capacity and includes a plurality of cloud servers 500. The remote server 20 is connected to the data center 50 via a network 40. The network 40 may be, but is not limited to, a wide area network (e.g., the Internet) or a local area network. The log file processing system 1 may receive log files from each of the cloud servers 500 when the cloud server 500 is rebooted. A log file is defined here as a file to record events in the cloud server 500. The log file is generated when the operating system is installed into the cloud server 500. The log file may include the number of reboots, the date and time for each rebooting, and error information if a reboot fails.

The remote server 20 has a pre-boot execute environment (PXE) service. The remote server 20 can boot the cloud servers 500 by means of the PXE service.

The remote server 20, in one example, can be also a dynamic host configuration protocol (DHCP) server. The remote server 20 has a DHCP service. In one embodiment, the remote server 20 assigns IP addresses to the cloud servers 500 by means of the DHCP service. The remote server 20 may provide three modes for allocating IP addresses to the cloud servers 500. The three modes are dynamic allocation, automatic allocation, and static allocation. In one embodiment, the remote server 20 uses dynamic allocation to assign the IP addresses to the cloud servers 500. For example, when the remote server 20 receives a request from a cloud server 500 via the network 40, the remote server 20 dynamically assigns an IP address, and offers the remote server 10 with the IP address. In one embodiment, the remote server 20 may be a personal computer (PC), a network server, or any other item of data-processing equipment.

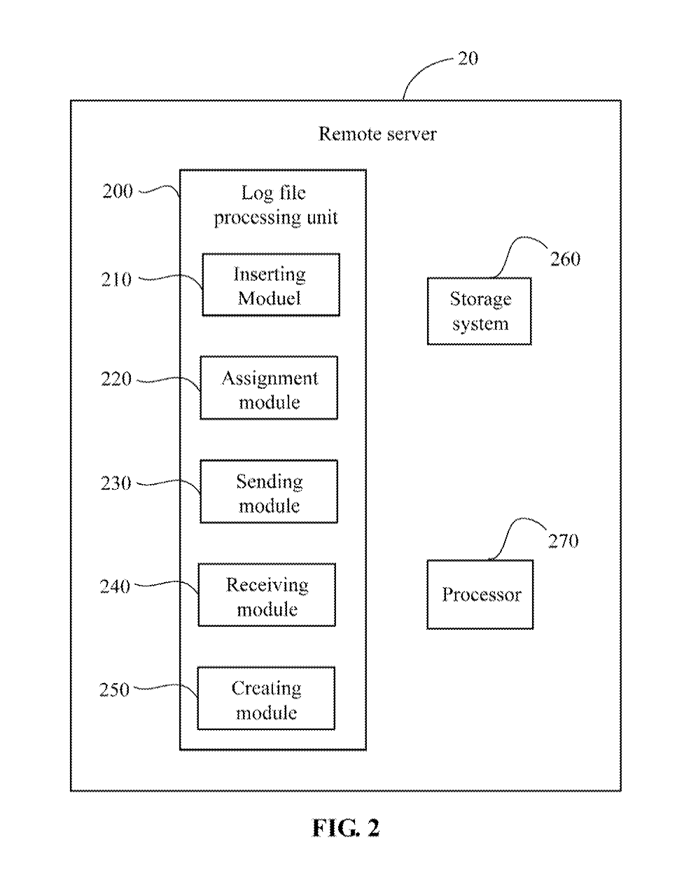

FIG. 2 is a block diagram of one embodiment of the remote server 20. The remote server 20 includes a log file processing unit 200. The log file processing unit 200 may be used to install an operating system (e.g., MICROSOFT WINDOWS operating system or LINUX operating system) in each of the cloud servers 500. In one embodiment, the remote server 20 includes a storage system 260, and at least one processor 270. In one embodiment, the log file processing unit 20 includes an inserting module 210, an assignment module 220, a sending module 230, a receiving module 240, and a creating module 250. The modules 210-250 may include computerized code in the form of one or more programs that are stored in the storage system 260. The computerized code includes instructions that are executed by the at least one processor 270 to provide functions for the modules 210-250. The storage system 260 may be a cache or a memory, such as an EPROM, HDD, or flash memory.

The inserting module 210 inserts test commands into an operating system image file stored in the storage system 260 of the remote server 40. It is understood that the operating system image file is defined as a compressed file that contains the complete contents and structures of an operating system. A user can use the operating system image file to install the operating system (e.g., MICROSOFT WINDOWS operating system or LINUX operating system) on a virtual basis in each of the cloud servers 500. In one embodiment, the operating system image file may be, but is not limited to, a MICROSOFT WINDOWS PREINSTALLATION ENVIRONMENT (WinPE). The test commands , as an example, are commands that control the number of times that a cloud server 500 is rebooted. For example, if a cloud server 500 is desired to be rebooted for three hundred times when a user wants to test the stability of the cloud server 500, the user inserts an appropriate test command(s) into the operating system image file. When the operating system is installed in the cloud server 500, the test command is executed and the cloud server 500 is rebooted three hundred times.

The assignment module 220 assigns an IP address by means of the DHCP service to each of the cloud servers 500 of the data center 50 to communicate with each of the cloud servers 500.

The sending module 230 sends the operating system image file to each of the cloud servers 500 by the PXE service and installs the operating system in each of the cloud servers 500 using the operating system image file.

The receiving module 240 receives a log file corresponding to the cloud server 500 that executes the test commands.

The creating module 250 creates a file name for the log file corresponding to the cloud server 500 and stores the log file into the storage system 260. Additionally, the creating module 250 may display the log file on a display device. The file name is derived from the IP address of the cloud server 500 as assigned by the remote server 20. For example, if the cloud server 500 is assigned an IP address “10.151.28.60”, the file name of the log file corresponding to that cloud server 500 is “10.151.28.60”. A user can easily and quickly search out the file log corresponding to any particular one of the cloud servers 500 according to the IP address.

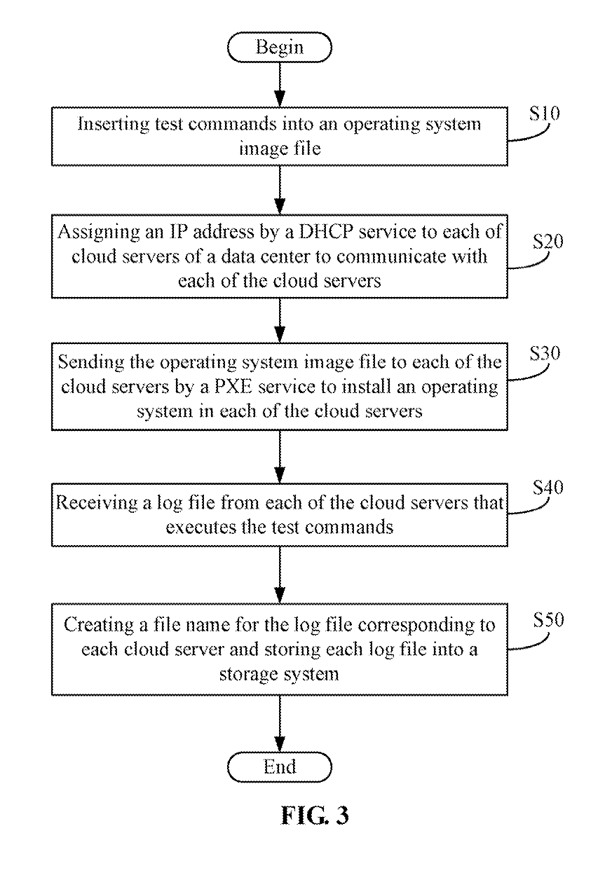

FIG. 3 is a flowchart of one embodiment of a log file processing method. Depending on the embodiment, additional blocks may be added, others deleted, and the ordering of the blocks may be changed.

In block S10, the inserting module 210 inserts test commands into an operating system image file stored in the storage system 260 of the remote server 40. As mentioned above, the operating system image file may be, but is not limited to, a MICROSOFT WINDOWS PREINSTALLATION ENVIRONMENT (WinPE). The test commands controls the times of the rebooting the cloud server 500. For example, if a cloud server 500 is desired to be rebooted three hundred times when a user wants to test the stability of the cloud server 500, the user inserts test commands into the operating system image file. When the operating system is installed in the cloud server 500, the test command is also executed and the cloud server 500 is rebooted three hundred times.

In block S20, the assignment module 220 assigns an IP address by means of the DHCP service to each of the cloud servers 500 of the data center 50 to communicate with each of the cloud servers 500.

In block S30, the sending module 230 sends the operating system image file to each of the cloud servers 500 by means of the PXE service and installs the operating system in each of the cloud servers 500 using the operating system image file.

In block S40, the receiving module 240 receives a log file corresponding to the cloud server 500 that executes the test commands.

In block S50, the creating module 250 creates a file name for the log file corresponding to the cloud server 500 and stores the log file into the storage system 260. Additionally, the creating module 250 may display the log file on a display device. The file name is derived from the IP address of the cloud server 500 as assigned by the remote server 20. For example, if the cloud server 500 is assigned “10.151.28.60” as an IP address, the file name of the log file originating from that cloud server 500 is “10.151.28.60.”

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer in electronic communication with cloud servers of a data center, comprising:
a storage system;
at least one processor; and
one or more programs stored in the storage system and being executable by the at least one processor, the one or more programs comprising:
an inserting module operable to insert test commands into an operating system image file stored in the storage system;
an assignment module operable to assign an IP address by a dynamic host configuration protocol (DHCP) service of the remote server to each of the cloud servers of the data center to communicate with each of the cloud servers;
a sending module operable to send the operating system image file to each of the cloud servers by a pre-boot execute environment (PXE) service of the remote server and install the operating system in each of the cloud servers using the operating system image file;
a receiving module operable to receive a log file corresponding to the cloud server that executes the test commands; and
a creating module operable to create a file name for the log file corresponding to the cloud server and store the log file into the storage system.

2. The remote server of claim 1, wherein the operating system image file is a compressed file that contains the complete contents and structures of the operating system.

3. The remote server of claim 1, wherein the file name for each log file is named after the IP address of the cloud server assigned by the remote server.

4. The remote server of claim 1, wherein the test commands control a number of times that the cloud server is rebooted.

5. A computer-based log file processing method being performed by execution of computer readable program code by a processor of a remote server, the remote server in electronic communication with cloud servers of a data center, the method comprising:
inserting test commands into an operating system image file stored in a storage system of the remote server;
assigning an IP address by a dynamic host configuration protocol (DHCP) service of the remote server to each of the cloud servers of the data center to communicate with each of the cloud servers;
sending the operating system image file to each of the cloud servers by a pre-boot execute environment (PXE) service of the remote server and installing the operating system in each of the cloud servers using the operating system image file;
receiving a log file corresponding to the cloud server that executes the test commands; and
creating a file name for the log file corresponding to the cloud server and storing the log files into the storage system of the remote server.

6. The method of claim 5, wherein the operating system image file is a compressed file that contains the complete contents and structures of the operating system.

7. The method of claim 5, wherein the file name for each log file is named after the IP address of the cloud server assigned by the remote server.

8. The method of claim 5, wherein the test commands control a number of times that the cloud server is rebooted.

9. A non-transitory computer-readable medium having stored thereon instructions that, when executed by a remote server, the remote server in electronic communication with cloud servers of a data center, causing the remote server to perform a log file processing method, the method comprising:
inserting test commands into an operating system image file stored in a storage system of the remote server;
assigning an IP address by a dynamic host configuration protocol (DHCP) service of the remote server to each of the cloud servers of the data center to communicate with each of the cloud servers;
sending the operating system image file to each of the cloud servers by a pre-boot execute environment (PXE) service of the remote server and installing the operating system in each of the cloud servers using the operating system image file;
receiving a log file corresponding to the cloud server that executes the test commands; and
creating a file name for the log file corresponding to the cloud server and storing the log files into the storage system of the remote server.

10. The medium of claim 9, wherein the operating system image file is a compressed file that contains the complete contents and structures of the operating system.

11. The medium of claim 9, wherein the file name for each log file is named after the IP address of the cloud server assigned by the remote server.

12. The medium of claim 9, wherein the test commands control a number of times that the cloud server is rebooted.
